(19) United States
(12) Patent Application Publication
(10) Pub. No.: US 2020/0304991 A1
(43) Pub. Date: Sep. 24, 2020

(54) APPARATUS AND SYSTEM FOR AUDIO TRANSMISSION OF A BOOK

(71) Applicants: Theresa Andreuccetti, Memphis, TN (US); Nikki Schroeder, Memphis, TN (US)

(72) Inventors: Theresa Andreuccetti, Memphis, TN (US); Nikki Schroeder, Memphis, TN (US)

(21) Appl. No.: 16/825,191

(22) Filed: Mar. 20, 2020

Related U.S. Application Data
(60) Provisional application No. 62/821,439, filed on Mar. 20, 2019.

(51) Int. Cl. H04W 12/00; G06F 21/84; H04W 76/14; H04R 1/02; A63H 3/02; A63H 3/28

(52) U.S. Cl. CPC H04W 12/003; G06F 21/84; H04W 76/14; A63H 2200/00; A63H 3/02; A63H 3/28; H04R 2420/07; H04R 1/028

(57) ABSTRACT

A system for secure audio transmission of a book to a toy, such that the book appears to be “read” by the toy. The system utilizes a computing component operatively connected to a speaker and housed inside said toy, wherein the computing component is securely connected to a mobile application, and wherein said mobile application allows a user to select one or more books to be “read” by the toy.

### CROSS-REFERENCE TO RELATED APPLICATION(S)

The present application derives priority from U.S. Provisional Patent Application Ser. No. 62/821,439, filed 20 Mar. 2019, the entirety of which is incorporated herein by reference.

### BACKGROUND OF THE INVENTION

### 1. Field of the Invention

The present invention relates generally to audio transmission and, more particularly, to a system and method for secure transmission of an audio book or other type of audio to a device designed specifically to be embedded in a soft child's toy.

### 2. Description of the Background

Children's toys, including stuffed animals and other soft toys, are well known in the art. Also known are toys which incorporate means to emit sound that is pre-programmed into the unit. However, these toys provide limited options for sound being played by the toy, and/or only a very small selection of audio is available, which is played on a non-customizable loop (much to the irritation of parents and caregivers).

In other fields, there currently exist speakers which can play audio of the user's selection at a distance away from the controller, such as via a Bluetooth connection.

However, there exists a need for a child's toy with the capability to emit audio of the user's choosing, whereby the selection of audio can be made using a device that is not physically connected to the toy. Moreover, there is a need for such a toy which provides a secure audio connection, to prevent unwanted audio from being played from said child's toy, or other sounds which are not suited for children to hear.

### SUMMARY OF THE INVENTION

Therefore, it is an object of the invention to provide a system for secure audio transmission of a book to a toy, such that the book appears to be “read” by the toy.

In accordance with the foregoing objects, the invention is a system utilizing a computing component operatively connected to a speaker and housed inside said toy, wherein the computing component is securely connected to a mobile application, and wherein said mobile application allows a user to select one or more books to be “read” by the toy.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a composite view of a system for the secure audio transmission of a book or other audio according to the present invention, showing an exploded view of the receiver device along with a transparent view of the toy in which one possible location of the receiver device within the toy is shown.

FIG. 2 is an illustration of a high-level implementation of how the computing component, speaker, battery, and software application of the present invention are operatively connected.

FIG. 3 is a composite diagram illustrating various screen shots of a mobile application associated with said system.

### DETAILED DESCRIPTION OF THE PREFERRED EMBODIMENT

Reference will now be made in detail to preferred embodiments of the present invention, examples of which are illustrated in the accompanying drawings.

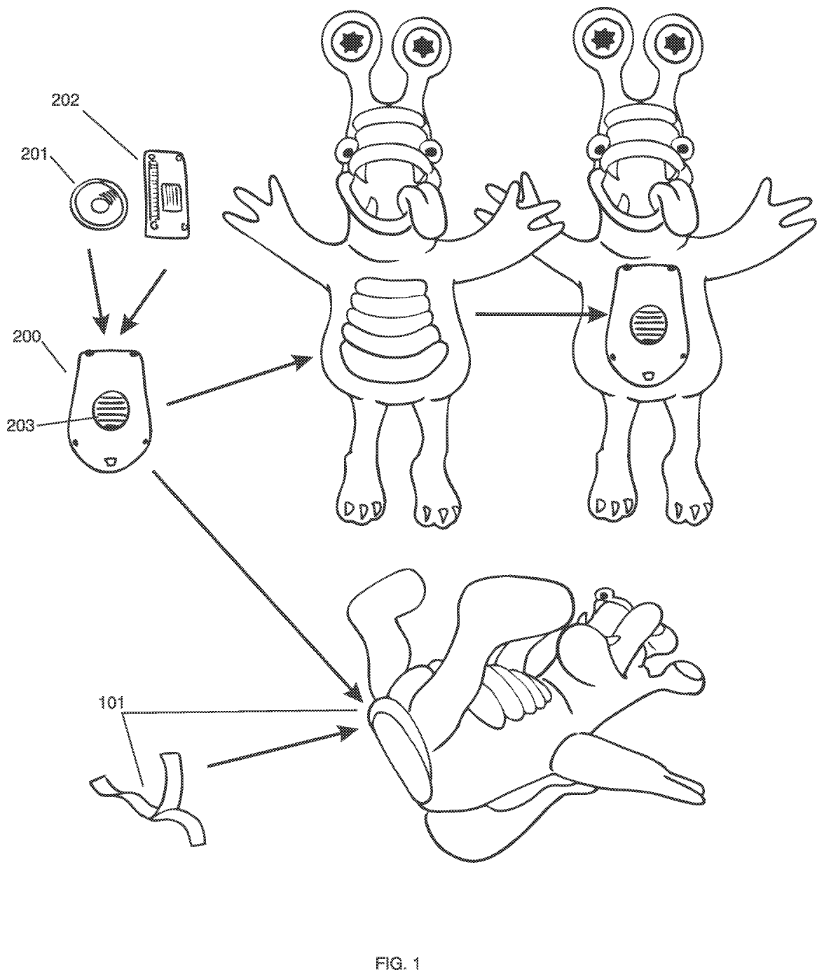

In one embodiment, the present invention consists of a reduced-size connected receiver having a secure connection to a transmission device such that the reduced-size connected receiver can only receive inputs and/or audio signals from a single receiver. FIG. 1 illustrates the key components of a preferred embodiment of the present invention. As shown therein, a receiver unit is comprised of a receiver housing 200, a computing component 202 and a speaker component 201. Receiver housing 200 comprises an interior cavity of sufficient size to enclose at least one computing component 202 and one speaker component 201. Preferably, receiver housing 200 is made of an insulating material, such as a high-density plastic (e.g., high-density polyethylene, polypropylene, etc.) or other material which will prevent (or reduce the amount of) heat generated by the components inside the housing from passing through the housing 200 to heat exterior components adjacent to the housing. In certain preferred embodiments, housing 200 may further enclose one or more heat sinks or comparable devices that can measure and/or control heat, the foregoing all being designed to prevent the exterior surface of the housing 200 from being hot or warm to the touch and from otherwise passing heat along to adjacent components of the inventive system. Also in some embodiments, housing 200 includes a screen 203 or other opening to allow sound to pass from the interior of housing 200 (from speaker component 201) through housing 200 with as little muffling of the sound as possible.

Housing 200 is preferably sized to fit within a toy 100, which in preferred embodiments is a hand puppet, stuffed animal or other form of soft toy. In the most preferred embodiments, toy 100 is a hand puppet made of a soft organic material and comprising stuffing, and in the shape of an animal having a head, mouth, main body portion, and one or more limbs including arms, legs, tail(s), etc. FIG. 1 illustrates toy 100 in the form of the Jabberblabber® puppet, which has two arms, two legs, a tail and a snout. However, other forms of toy that may desirably incorporate the inventive system as described herein may be envisioned, such as rubber toys, waterproof bath toys, balls and the like.

Preferably, the receiver unit is located adjacent to a mouth, if any, if the toy into which it is incorporated. However, alternate configurations are possible, and depend on the type of toy. In preferred embodiments, though, the receiver unit will be removably located in a spot where it can be easily accessed, so that the receiver unit can be removed from the toy for charging, repair, and/or to wash the toy. This may be accomplished by building a re-sealable opening in the toy, which is sealed by some fastening means 101 such as Velcro, a zipper, buttons or the like. In FIG. 1, the receiver unit is shown in the belly area of the Jabberblabber® puppet.

Inside housing 200, speaker component 201 and computing component 202 are operatively connected such that computing component 202 can control the audio signal being sent to speaker 201. In some embodiments, speaker 201 and computing component 202 may be integrated into a single physical device. In still further embodiments, all three components, including speaker 201, computing component 202 and housing 200 may all be integrated into a single physical device.

In certain embodiments, the computing component is a small handheld computer configured to communicate with, and control the audio emitted from, speaker 201. Computers of the type capable of providing this functionality include a Raspberry Pi or similar handheld computer. In certain embodiments, computing component 202 is configured to communicate with a speaker 201. In other preferred embodiments, a speaker is integrated directly into computing component 202. In either case, computing component 202 is configured and programmed to provide an audio signal to speaker 201. Preferably, all of the interior components including computing component 202 and speaker 201 include an integrated power source, which can be a lithium ion battery, conventional battery, a USB power supply, or other power means known in the art.

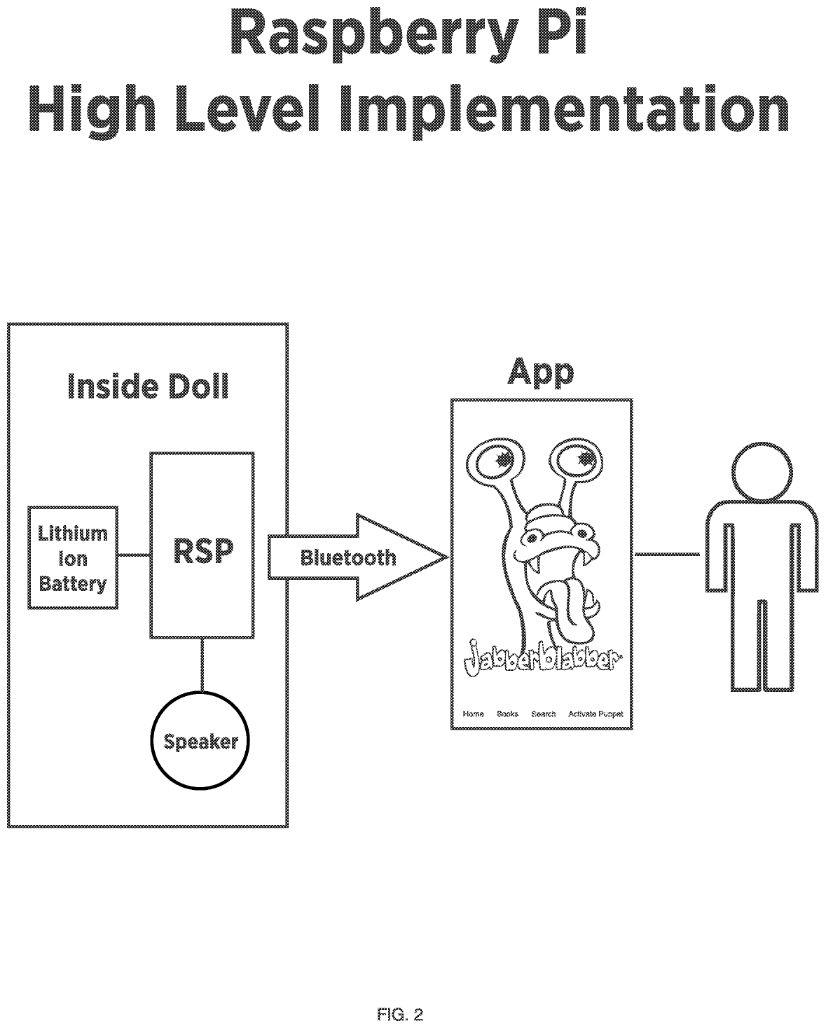

The computing component 202 is configured to receive data transmission from a software application. The application is preferably run on a handheld computing device, such as a phone or tablet. The connection between computing component 202 and the computer application is preferably wireless, such as by Bluetooth or some other Intranet now known or developed in the future, but may also be a conventional wired connection. For example, the computing component 202 and speaker 201 may be integrated into a Bluetooth speaker device. FIG. 2 is an illustration of a high-level implementation of how the computing component (RSP), speaker 201, battery, and software application are operatively connected.

The software application is configured to allow a user to choose from a list of audio files to be played on the speaker 201. Critically, the software application and computing component 202, and consequently speaker 201, are securely paired such that only audio files designated by the software application may be transmitted to be played by speaker 201. This may be accomplished in one or more ways.

In certain embodiments, a unique code will be provided to the recipient of the toy in which the receiver unit is incorporated, either in the product packaging and/or via an online or mail-in registration process. The same code will be coded into the computing component 202 of the receiver unit embedded in the toy with which the code is provided. Then, one or more software applications (e.g., each on one or more mobile devices or tablets) which the users wishes to pair with the receiver unit will request that the user input the unique code upon download and/or first use of the software application. Once an initial connection is established between the software application and the computing component 202, computing component 202 will request, or the software application will be programmed to transmit, the unique code, which will be verified by the computing component 202 onboard the toy. If the code sent by the software application matches the unique code programmed into the computing component 202, the software application can then “pair” with the computing component, and only that software application can transmit audio files to the computing component 202, which will thereby restrict the audio files being played by the speaker 201 embedded in the toy.

In certain embodiments, “pairing” of the computing component 202 will only be possible with one computer application, on a single device. In preferred embodiments, pairing will be possible between the computing component 202 and multiple computer applications. In other preferred embodiments, the total number of computer applications and/or the identities of the individual devices running such applications, with which the computing component 202 will be able to pair will be set by the user, possibly via inputs made via the application interface of the software application that first pairs with the computing component 202.

In one preferred embodiment, the software application will include instructions on how to activate the computing component 202 and speaker 201.

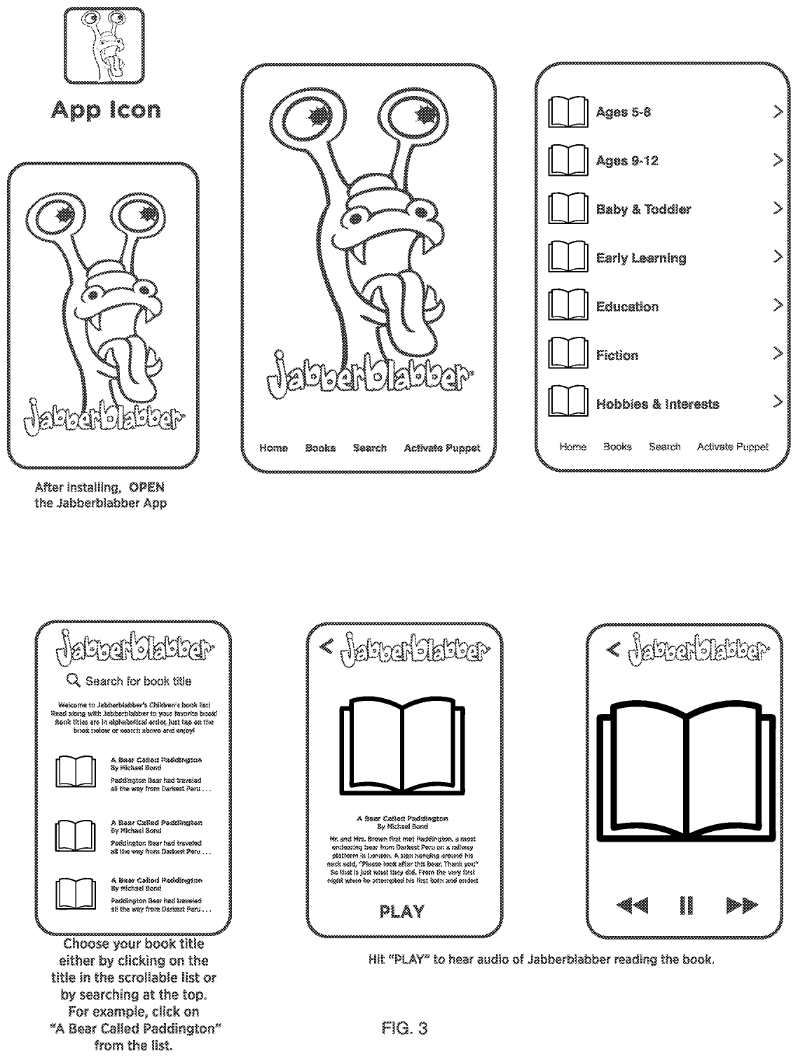

A flow chart depicting the steps performed by the computer application which is or will be paired with the computing component 202 is shown in FIG. 3. The computer application can be downloaded onto the user's device. An icon representing the application will be displayed on the user's device once downloaded. The user will click on the icon to open the application. As shown in FIG. 3, an initial screen which appears upon application startup preferably gives the user options for activating the receiver unit (computing component 202 and speaker 201) in the toy (as previously described), choosing a book to play through speaker 201, and/or searching for content. In the most preferred embodiments of the present invention, the mobile application is designed, and its database is organized, specifically to allow the user to select a book to be “read” by the toy, via speaker 201. FIG. 3 illustrates how audio files, preferably books, available to be played through speaker 201 will be organized, and how play, pause, fast forward and rewind functionalities can be built into the computer application to be “read” (played via speaker 201) by the toy.

In other preferred embodiments of the present invention, the computer application will show the user an indication of power (on/off) and/or batter life of the receiver unit in the toy.

In other preferred embodiments, the software application will show video content on the user interface of the software application on the device, either in addition to or instead of audio content being transmitted to the speaker 201 for playing through the toy. Optional video content can include a video of a book with a hand (potentially the hand of a stuffed animal toy or puppet) turning the pages of the book, along with audio of a person reading the book shown on the screen, and/or music.

Although the present subject matter has been described with reference to specific exemplary embodiments, it will be evident that various modifications and changes may be made to these embodiments without departing from the broader spirit and scope of the subject matter. Accordingly, the specification and drawings are to be regarded in an illustrative rather than exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

1. A system for secure audio transmission of a book to a toy, the system comprising:
a soft toy;
a computing component;
a speaker operatively connected with said computing component;
an insulating casing, wherein said computing device and said speaker are housed within said insulating casing, and wherein said insulated casing is removable from said soft toy; and
one or more mobile devices running one or more mobile applications;
wherein said one or more mobile devices are capable of being securely paired with said computing component.

2. The system of claim 1, wherein said one or more mobile devices are capable of being securely paired with said computing component via a Bluetooth connection.

3. The system of claim 1, wherein said computing component is configured to restrict the number of said mobile devices capable of being securely paired with same computing component.

4. The system of claim 3, wherein said number of said mobile devices capable of being securely paired with said computing component is 1.

5. The system of claim 3, wherein said number of said mobile devices capable of being securely paired with said computing component is 2.

6. The system of claim 1, wherein said computing component is configured to restrict the number of said one or more mobile applications from which it receives inputs.

7. The system of claim 6, wherein the number of said one or more mobile applications from which said computing component receives inputs is restricted to one.

8. The system of claim 3, wherein said computing component is configured to restrict the number of said one or more mobile applications from which it receives inputs.

9. The system of claim 8, wherein the number of said one or more mobile applications from which said computing component receives inputs is restricted to one.

10. The system of claim 1, wherein said one or more mobile applications are configured to provide inputs in the form of audio files to said computing component.

11. The system of claim 10, wherein said audio files comprise audio of an individual reading a children's book.

12. The system of claim 1, wherein said mobile application from which said computing component receives input is configured to perform the following steps:
prompt a user for a unique code;
transmit said unique code to said computing component;
receive a signal from said computing component which either confirms or denies that said unique code matches an embedded code which is pre-programmed into said computing component; and
allow said one or more mobile devices to pair securely with said computing component only if said unique code matches said embedded code.

13. The system of claim 9, wherein said mobile application from which said computing component receives input is configured to perform the following steps:
prompt a user for a unique code;
transmit said unique code to said computing component;
receive a signal from said computing component which either confirms or denies that said unique code matches an embedded code which is pre-programmed into said computing component; and
allow said one or more mobile devices to pair securely with said computing component only if said unique code matches said embedded code.

14. The system of claim 13, wherein said mobile application is further configured to perform the following steps:
provide a menu to said user, said menu containing a list of audio files available to be transported from said mobile application to said speaker; and
transport a selected one of said audio files to said computing component.

15. The system of claim 1, wherein said mobile application is configured to perform the following steps:
provide a menu to a user, said menu containing a list of audio files available to be transported from said mobile application to said speaker; and
transport a selected one of said audio files to said computing component.

16. The system of claim 1, wherein said soft toy is a stuffed animal.

17. The system of claim 1, wherein said insulating casing comprises one or more openings proximate said speaker, to reduce muffling of sound transmitted from said speaker through said insulated casing.

18. The system of claim 13, wherein said insulating casing comprises one or more openings proximate said speaker, to reduce muffling of sound transmitted from said speaker through said insulated casing.
